(19) United States
(12) Patent Application Publication
(10) Pub. No.: US 2024/0144167 A1
(43) Pub. Date: May 2, 2024

(54) System and Related Methods for Managing Last-Mile Deliveries

(71) Applicants: Uri Reznik, Frankfurt am Main (DE); Markus Haaga, Wiesbaden (DE); Ludovico Camarda, Darmstadt (DE)

(72) Inventors: Uri Reznik, Frankfurt am Main (DE); Markus Haaga, Wiesbaden (DE); Ludovico Camarda, Darmstadt (DE)

(21) Appl. No.: 17/975,641

(22) Filed: Oct. 28, 2022

(51) Int. Cl. G06Q 10/0836; G06Q 10/02; G06Q 10/0833; G06Q 50/30; G06T 7/60; G06V 40/16; G07C 9/00

(52) U.S. Cl. CPC G06Q 10/0836; G06Q 10/02; G06Q 10/0833; G06Q 50/30; G06T 7/60; G06V 40/172; G07C 9/00571; G07C 9/00896

(57) ABSTRACT

The present disclosure relates to a system and related methods for automatically managing the last mile phase of package and parcel deliveries. This is achieved by automatically detecting tracking information on the user device of an individual having access to a smart locker and generating a reservation record and smart contract for the delivery. The courier scans the parcel at the appropriate smart locker, which verifies that the package matches a reservation record and can then take a set action, unlocking the smart locker door or initiating a call with a recipient or peer. The cost efficiency of the last mile phase is thus drastically improved, increasing supply chain certainty and reducing the need for repeated deliveries.

### FIELD OF INVENTION

The present invention relates generally to a computer-implemented delivery management system. More specifically, the present invention relates to a delivery management system for automating parts of the last mile phase of postal deliveries.

### BACKGROUND

The delivery of packages and parcels to a postal address while the recipient is away has become a standard practice and has grown exponentially due to the increase of online consumer shopping. Customers order an increasing number of products and types of products for delivery to their home or business rather than visiting a local business in person to purchase the products.

For logistics companies providing courier, package delivery, and express mail services to fulfil this need, the biggest area of opportunity for process optimization and cost reduction is known as the “Last Mile” phase. This phase is the final link of the delivery chain, where an item gets transported from a warehouse or other centralized location to its destination, and is by far the most expensive and time-consuming part of the delivery process. This is due to its unpredictable nature, in contrast to all prior steps of the order fulfilment process which involve highly optimized and predictable logistics. It also requires highly costly infrastructure—delivery vehicles and paid drivers.

Major issues in this phase include: the recipient not being home or available to receive the parcel, parcels left unattended being subject to theft or environmental damage, parcel re-delivery required, parcel return required, and returned or undelivered parcels leading to dissatisfied customers.

Parcel deliveries are often missed because no one is present to accept the parcel, because no one is free to answer the door to accept the parcel, because one is at work, because one is traveling, and various other reasons. If a parcel is left outside, it may not be picked up for an extended period of time if the person is traveling, is staying at another residence, and/or does not realize the parcel has been left. Shipping companies often leave door tags giving the recipient the option of scheduling a re-delivery or picking up the parcel or package at another location.

Internet merchants often absorb the delivery costs, while still coping with issues like incorrect addresses, remote locations, and order returns, with the aim of improving customer satisfaction and loyalty.

There is a need for an improved delivery management system which allows merchants and couriers to match customer expectations with reduced cost while maintaining a high level of security for delivered parcels, fast delivery, meeting narrow delivery windows, and maintaining full transparency and traceability to match customer expectations.

It is within this context that the present invention is provided.

### SUMMARY

The present disclosure relates to a system and related methods for automatically managing the last mile phase of package and parcel deliveries. This is achieved by automatically detecting tracking information on the user device of an individual having access to a smart locker and generating a reservation record and smart contract for the delivery. The courier scans the parcel at the appropriate smart locker, which verifies that the package matches a reservation record and can then take a set action, unlocking the smart locker door or initiating a call with a recipient or peer. The cost efficiency of the last mile phase is thus drastically improved, increasing supply chain certainty and reducing the need for repeated deliveries.

The system may in some examples also have a bidirectional aspect, allowing management not only of the delivery of parcels, but of the return, with a user being able to organise a return through their device, leaving a parcel in the smart locker for collection by a courier.

According to a first aspect of the present disclosure, there is provided a computer-implemented system for managing deliveries, the system comprising: a database, the database having stored thereon user data for a plurality of users and a plurality of user devices, each user device being associated with a set of user data stored in the database and having installed thereon software for detecting and forwarding delivery information.

The system further comprises one or more smart locker devices, each smart locker device comprising: a communal storage space enclosed by an electronically operated door lock; a communications unit; one or more camera devices; a scanning device; a controller, the controller being configured to: scan a parcel ID code to determine delivery information and a tracking ID, and to forward the tracking ID and delivery information for verification; and scan a user device, verify that the user device is associated with user data for which a package is being stored inside the communal storage space, and open the door lock.

The system further comprises one or more servers, the one or more servers being configured to: receive delivery information from a user device, the delivery information comprising a tracking ID and user data associated with the user device; verify that the tracking ID is valid and relates to a delivery address that matches the user data from the database; generate a reservation record and initiate a smart contract for the tracking ID; receive a notification from a smart locker associated with the delivery address that a parcel associated with a tracking ID has been scanned at the smart locker; and verify that the tracking ID of the parcel scanned at the smart locker matches the tracking ID associated with the generated reservation record.

In some embodiments, in response to receiving a confirmation from the one or more servers that the tracking ID for the parcel has been verified, the smart locker controller is configured to open the electronically locked door for the parcel to be placed inside the locker space.

In such embodiments, the smart locker controller may be further configured to track the amount of available space inside the locker, and to keep the door locked if the calculated space is below a predetermined threshold.

Additionally, the smart locker controller may, in response to such a determination, initiate a call with a user device associated with the reservation record. The smart locker controller may also, in response to such a determination, initiate a call with a peer of the user device associated with the reservation record, each peer of the user device having been granted peer delivery permissions by the user device associated with the reservation record. The smart locker controller may also notify the user device associated with the reservation record of which peer user device was contacted.

In further embodiments, the smart locker controller is further configured, in response to the door being unlocked for a successful parcel verification, capture an image of the delivered parcel and determine the parcel dimensions. It may be further configured to then send a notification to a user device associated with the reservation record, the notification containing the image and parcel dimensions as proof of delivery.

It may be further configured, in response to opening the door upon successful user device verification for collecting a parcel, to capture an image of the parcel removed by the user and determine whether the dimensions of the parcel removed match the dimensions of the parcel delivered, and to, upon determining that the parcel dimensions do not match, generate an alert or alarm notification.

In some embodiments, each smart locker further comprises a speaker and a microphone and is configured to initiate a call with a user device associated with a set of user data from the database.

In such embodiments, each smart locker may comprise a manual control panel configured to allow user devices associated with a particular delivery address to be contacted via a respective smart locker. The one or more servers may also be further configured, in response to verifying the tracking ID of the parcel, initiate a call with the user device associated with the reservation record, and/or to, in response to finding that the tracking ID of the parcel does not match a reservation record on the servers, find a set of user data that matches the delivery data of the scanned parcel and initiate a call with a user device associated with the user data.

In some embodiments, the software installed on the user device is a matching algorithm software configured to detect that a communication containing a tracking number has been received.

In some embodiments, each user device is further configured to allow manual entry of delivery information and a tracking ID in the case that the matching algorithm cannot detect the communication.

In some embodiments, the one or more servers are configured to respond to the verification of the tracking ID of the parcel based on one or more user preferences set by the user device associated with the user data.

In some embodiments, each time the door of a smart locker is opened, the controller is configured to record a video of the locker space via a camera of the smart locker and save or forward the video to the database.

In some embodiments, the smart locker controller is further configured to perform facial recognition on any individual in an image captured by the one or more cameras.

In some embodiments, the smart locker further comprises a solar panel connected to a standalone power source for autonomous operation.

In some embodiments, the smart locker controller is further configured, in response to a request from an associated user device, to open the electronic lock and allow a user to place a return parcel inside for collection by a courier.

### BRIEF DESCRIPTION OF THE DRAWINGS

Various embodiments of the invention are disclosed in the following detailed description and accompanying drawings.

FIG. 1 illustrates an example configuration of a system architecture over which the methods of the present disclosure may be implemented.

FIG. 2 illustrates a perspective isometric view of a first example configuration of a smart locker suitable for use in the system and methods of the present disclosure with the smart lock door open.

FIG. 3 illustrates a flow chart of an example set of steps carried out by the system of the present disclosure to implement the disclosed methods.

FIG. 4 illustrates a perspective isometric view of a second example configuration of a smart locker suitable for use in the system and methods of the present disclosure with the smart lock door closed.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

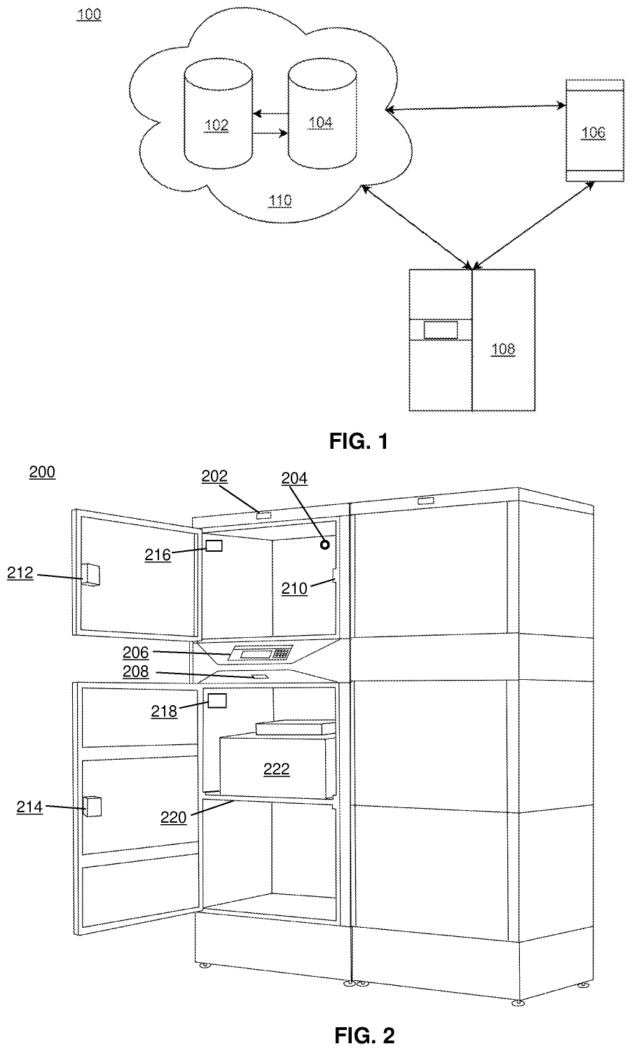

Referring to FIG. 1, an example configuration of a system architecture 100 over which the methods of the present disclosure may be implemented is shown. The disclosed solution is based on communal shared smart lockers 108 which are intended to be installed at multi-tenant properties.

The system may be run, in some examples, by three separate software applications, and one or more portions of it are implemented by smart contracts for increased automation and security.

The first application is a mobile app running on the user's smartphone 106. This app is integrated with the user's email account(s), and is configured to retrieve valid tracking numbers from shipping notifications and create a reservation record for each unique tracking number identified. The app also supports voice and video connection with the smart locker 108 and may also allow selecting/opening a locker 108 if enough space is available inside.

The second application runs on the smart locker controller. It supports QR/barcode scanning, audio/video connection, vision recognition, and distributed sensing. This app is therefore responsible for the handling of smart locker sensors, opening/closing lockers, and also supports voice and video connection.

The third app is a server-side application running in the cloud 110 through a combination of servers 102 and databases 104. It is the central fulcrum that connects every mobile app and every smart locker controller. Its main purpose is to maintain and manage user information and delivery information by collecting and storing them in the centralized database. Likewise, Internet of Things data are collected and stored by the server application, which also handles data security and secure communications, by implementing hardware encryption tokens (i.e. WiBu).

The database 104 is configured to store user information, such as names, delivery addresses, associated smart lockers, and user device contact information, for all participants of the system. It is also configured to store all tracking data and reservation records for parcel delivered or in the process of being delivered via the system.

The servers and database 102 and 104 in the cloud 110 are communicatively coupled with many user devices 106 and smart lockers 108. Each user device may be associated with one or more smart lockers 108 so that a user can manage parcel deliveries at addresses associated with those smart lockers 108. Each smart locker is configured both to communicate with the user devices directly and with the cloud architecture.

While the disclosed example uses smartphones, other types of client devices could also be used such as a personal computer, a laptop, a tablet computer, and a smart display that has a wired connection to a networked computer. Such client devices may be operationally coupled to a wide area network (WAN) such as the Internet with a wireless connection and may be communicatively coupled to the WAN via a Wi-Fi (or Bluetooth) access point that is in turn communicatively coupled to a modem. The wireless clients may also be communicatively coupled to the WAN using a proprietary carrier network that includes a communication tower.

Referring to FIG. 2 a perspective isometric view of a first example configuration of a smart locker 200 suitable for use in the system and methods of the present disclosure is shown, with the smart lock doors open.

As can be seen, in the present example the smart locker 200 is constituted by two stacked communal lockers, each equipped with an electronic lock, open/close sensor, and multiple digital cameras all controlled by a process controller.

Each controller has internet connection via mobile technology (LTE/4G), local area network for clustering multiple boxes together, and supports multiple cameras and vision recognition for sizing of the packages. Additional sensors such as IMU, GPS, proximity, light, etc. may also be present, as well as a display, microphone, speaker and IoT capabilities.

In the disclosed example there is a first camera and proximity sensor 202 located at the top of the smart locker 200. When a person is detected approaching the locker, the control display 206 is turned on. The camera also records individuals approaching the locker to deter or prevent theft and vandalism.

A light 204 is installed at the rear interior of the locker. This may be turned on automatically when the locker is opened, or if it is determined that it is dark outside when opened. The light 204 helps the user see the interior and helps the camera 202 capture their image.

The control panel 206 may be used to enter information manually and to adjust various settings. It may be a touchscreen interface, and may also comprise a keypad.

A second camera 208 is positioned below the control panel 206, this camera 208 may be configured for scanning parcel identifiers such as QR codes and bar codes. It may also comprise an NFC sensor for scanning chips. The lower camera 208 also serves a dual purpose, allowing the lower locker to be filmed to deter theft.

A smart lock, controlled by the smart locker controller, is installed in each of the upper and lower lockers. It has a wall mounted component 210 and a door mounted component 212/214. These locks are opened when a successful parcel verification is made and other conditions are met, such as appropriate user settings of the recipient and determination that the locker has enough space for the parcel. The locks may also comprise sensors for determining the lock status.

Another set of cameras and lights 216 and 218 are also provided inside each portion of the locker to detect the remaining space for parcels inside the locker, with this metric being tracked by the controller and used to determine whether couriers are allowed to deposit parcels in the locker. These also help prevent theft and help with general lighting of the locker interior.

The lower portion of the example locker 200 may have a retractable, foldable shelf 220 that can be used to divide it. In the illustrated example a pair of parcels 222 are resting on the shelf, waiting for collection by a recipient or peer.

Though not illustrated, the locker can also be equipped with a solar panel connected to a lithium battery for long-term autonomous operation.

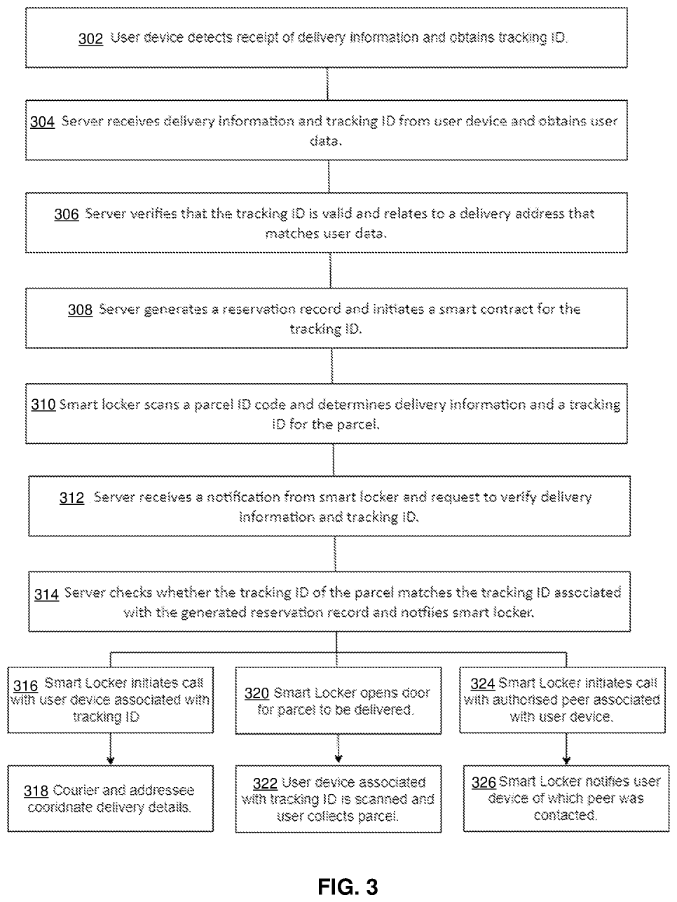

Referring to FIG. 3, a flow chart of an example set of steps carried out by the system of the present disclosure to implement the disclosed methods is shown.

In step 302, the user has completed an online purchase, and receives a shipping notification containing a tracking number on their phone. The matching algorithm of the system, installed on the smart phone, recognizes the tracking number automatically, which is then checked for validity. In exceptional cases (i.e. shipping notification given via a phone call) the user can manually enter the tracking number on their mobile device.

In step 304, the server receives the tracking number (tracking ID) and delivery information from the user device. The delivery information may simply be information identifying the user of the phone, whose delivery address and associated smart lockers can then be looked up in the database.

In step 306, the server verifies that the tracking ID is valid. This may done, for example, by interfacing with a courier service, or online merchant via an API to check that. The server then also checks that the order relates to a delivery address that matches the user data from the database, i.e. correct address and name for a system participant.

Once this is confirmed, in step 308, the server generates a reservation record and initiates a smart contract for handling that particular tracking ID. The reservation record and smart contract for the tracking ID remain valid until the parcel is delivered by the courier.

At step 310, the shipping courier arrives at the address for delivering the package, approaches the smart locker, and scans the package barcode. The server receives a notification from the smart locker that a parcel associated with a tracking ID that matches a reservation record has been scanned at the smart locker.

At step 312, the server checks that the smart locker is associated with the correct delivery address which matches the tracking ID associated with the generated reservation record, and sends a confirmation to the smart locker.

At this point, the action the smart locker takes will depend on how it is configured, user preferences of the user associated with the reservation record, and the current available storage within the smart locker.

In step 316, if the user is at home (something they can indicate in the settings of their user device), if a reservation record for the scanned code is not found, or if the user preferences of the recipient are set to “always ring”, the smart locker is configured to initiate an audio/video communication between the smart locker and the user's device.

Thus, in step 318, the recipient's device rings in response to the parcel barcode being scanned and a voice and video connection is established with the smart locker, allowing the courier and the user to talk. The recipient can receive his parcel personally if he is at home, or if the user is not at home, and enough space is in the locker, the user can remotely open the smart locker (the one their profile is associated with) allowing the courier to deliver the parcel into it.

Alternatively, if the user is not at home, a matching reservation record for the scanned parcel is found to exist, and user preferences are set to “always open the smart locker”, then instead of initiating the call the smart locker is configured, in step 320, to check that the locker has enough space available for the parcel and if so, to open the locked door of the smart locker, allowing the courier to deliver the parcel into it.

If the locker is determined not to have enough space available for the parcel, a call is initiated between the locker and the recipient's user device and the user and courier can agree on an alternative delivery location, or a different time for a second delivery attempt.

During the courier's interaction with the smart locker, a live video is recorded and transmitted to the server side. During video recording the package size and image is captured by visual recognition. A picture of the package delivered and its size is sent to the user's app as proof of delivery.

In step 322, the recipient of the parcel then approaches the locker and identifies himself by scanning his user device. If a package was delivered for him, the locker opens, and he can pick up the parcel. The action is video recorded, and the size and image of the package he picks up are matched to the one captured during delivery. If there is no matching, an alarm and/or notification is triggered and the event is logged on the server.

Alternatively, if the user is participating in the peer delivery initiative then another option is possible. The matching algorithms of the system can check which users are at home, and propose them as an alternative delivery location for other users at or nearby the same delivery address. A user participating in peer delivery can thus transfer his right to pick up the package to any other user of the system by, for example, entering the peer's email address in the app. A smart contract is then transferred to the peer, enabling him to open the locker and pick up the parcel.

Thus, in step 324, if the recipient is not at home and is participating in the peer delivery initiative, the smart locker determines which peer the permissions have been given to, and initiates a call with the peer's user device to allow the courier to co-ordinate delivering the parcel to the peer. This step may include a notification being sent to the original recipient's user device, allowing them to see which peers are currently at home, and select him/her as alternative delivery location for his parcel.

In step 326, the original recipient will be notified which peer and which location the parcel was delivered to.

The package's whereabout can be checked anytime in this manner in the mobile application.

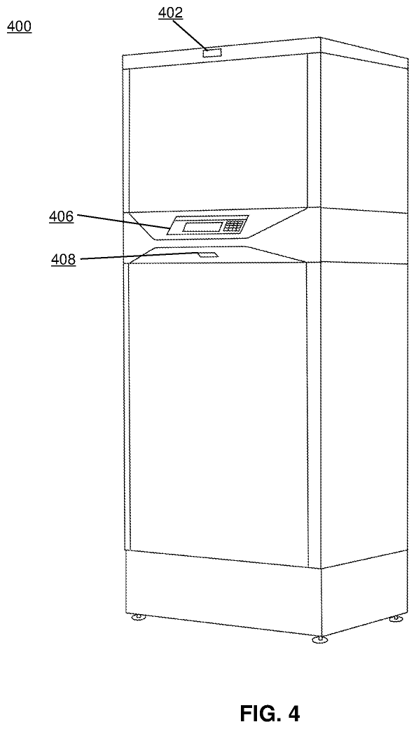

Referring to FIG. 4, a perspective isometric view of a second example configuration of a smart locker 400 suitable for use in the system and methods of the present disclosure with the smart lock door closed.

This smaller version may be used for smaller multi-tenant properties, having only one set of doors. It still has all of the same external features such as the top camera and light 402, the control interface 406, and the barcode/QR code scanning camera 408.

In examples where the system is further configured to handle the return of parcels, the software running on the user devices may be configured to allow them to initiate a return via the app, gaining access to an associated smart locker, provided there is sufficient space available, and to leave a package to be returned inside for collection by a courier.

It should be understood that the operations described herein may be carried out by any processor. In particular, the operations may be carried out by, but are not limited to, one or more computing environments used to implement the method such as a data center, a cloud computing environment, a dedicated hosting environment, and/or one or more other computing environments in which one or more assets used by the method re implemented; one or more computing systems or computing entities used to implement the method; one or more virtual assets used to implement the method; one or more supervisory or control systems, such as hypervisors, or other monitoring and management systems, used to monitor and control assets and/or components; one or more communications channels for sending and receiving data used to implement the method; one or more access control systems for limiting access to various components, such as firewalls and gateways; one or more traffic and/or routing systems used to direct, control, and/or buffer, data traffic to components, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the method; one or more databases used to store data; one or more internal or external services used to implement the method; one or more backend systems, such as backend servers or other hardware used to process data and implement the method; one or more software systems used to implement the method; and/or any other assets/components in which the method is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

As used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

Unless specifically stated otherwise, as would be apparent from the above discussion, it is appreciated that throughout the above description, discussions utilizing terms such as, but not limited to, “activating”, “accessing”, “adding”, “applying”, “analyzing”, “associating”, “calculating”, “capturing”, “classifying”, “comparing”, “creating”, “defining”, “detecting”, “determining”, “eliminating”, “extracting”, “forwarding”, “generating”, “identifying”, “implementing”, “obtaining”, “processing”, “providing”, “receiving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system and method have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A computer-implemented system for managing deliveries, the system comprising:
a database, the database having stored thereon user data for a plurality of users;
a plurality of user devices, each user device being associated with a set of user data stored in the database and having installed thereon software for detecting and forwarding delivery information;
one or more smart locker devices, each smart locker device comprising:
a communal storage space enclosed by an electronically operated door lock;
a communications unit;
one or more camera devices;
a scanning device;
a controller, the controller being configured to:
scan a parcel ID code to determine delivery information and a tracking ID, and to forward the tracking ID and delivery information for verification; and
scan a user device, verify that the user device is associated with user data for which a package is being stored inside the communal storage space, and open the door lock;
one or more servers, the one or more servers being configured to:
receive delivery information from a user device, the delivery information comprising a tracking ID and user data associated with the user device;
verify that the tracking ID is valid and relates to a delivery address that matches the user data from the database;
generate a reservation record and initiate a smart contract for the tracking ID;
receive a notification from a smart locker associated with the delivery address that a parcel associated with a tracking ID has been scanned at the smart locker; and
verify that the tracking ID of the parcel scanned at the smart locker matches the tracking ID associated with the generated reservation record.

2. A computer-implemented system for managing deliveries according to claim 1, wherein in response to receiving a confirmation from the one or more servers that the tracking ID for the parcel has been verified, the smart locker controller is configured to open the electronically locked door for the parcel to be placed inside the locker space.

3. A computer-implemented system for managing deliveries according to claim 2, wherein the smart locker controller is further configured to track the amount of available space inside the locker, and to keep the door locked if the calculated space is below a predetermined threshold.

4. A computer-implemented system for managing deliveries according to claim 3, wherein the smart locker controller is further configured, in response to such a determination, initiate a call with a user device associated with the reservation record.

5. A computer-implemented system for managing deliveries according to claim 3, wherein the smart locker controller is further configured, in response to such a determination, to initiate a call with a peer of the user device associated with the reservation record, each peer of the user device having been granted peer delivery permissions by the user device associated with the reservation record.

6. A computer-implemented system for managing deliveries according to claim 5, wherein the smart locker controller is further configured to notify the user device associated with the reservation record of which peer user device was contacted.

7. A computer-implemented system for managing deliveries according to claim 2, wherein the smart locker controller is further configured, in response to the door being unlocked for a successful parcel verification, capture an image of the delivered parcel and determine the parcel dimensions.

8. A computer-implemented system for managing deliveries according to claim 7, wherein the smart locker controller is further configured to then send a notification to a user device associated with the reservation record, the notification containing the image and parcel dimensions as proof of delivery.

9. A computer-implemented system for managing deliveries according to claim 7, wherein the smart locker controller is configured, in response to opening the door upon successful user device verification for collecting a parcel, to capture an image of the parcel removed by the user and determine whether the dimensions of the parcel removed match the dimensions of the parcel delivered.

10. A computer-implemented system for managing deliveries according to claim 9, wherein the smart locker controller is further configured upon determining that the parcel dimensions do not match, to generate an alert or alarm notification.

11. A computer-implemented system for managing deliveries according to claim 1, wherein each smart locker further comprises a speaker and a microphone and is configured to initiate a call with a user device associated with a set of user data from the database.

12. A computer-implemented system for managing deliveries according to claim 11, wherein each smart locker comprises a manual control panel configured to allow user devices associated with a particular delivery address to be contacted via a respective smart locker.

13. A computer-implemented system for managing deliveries according to claim 11, wherein the one or more servers are further configured, in response to verifying the tracking ID of the parcel, initiate a call with the user device associated with the reservation record

14. A computer-implemented system for managing deliveries according to claim 11, wherein the one or more servers are further configured, in response to finding that the tracking ID of the parcel does not match a reservation record on the servers, to find a set of user data that matches the delivery data of the scanned parcel and initiate a call with a user device associated with the user data.

15. A computer-implemented system for managing deliveries according to claim 1, wherein the software installed on the user device is a matching algorithm software configured to detect that a communication containing a tracking number has been received.

16. A computer-implemented system for managing deliveries according to claim 1, wherein each user device is further configured to allow manual entry of delivery information and a tracking ID in the case that the matching algorithm cannot detect the communication.

17. A computer-implemented system for managing deliveries according to claim 1, wherein the one or more servers are configured to respond to the verification of the tracking ID of the parcel based on one or more user preferences set by the user device associated with the user data.

18. A computer-implemented system for managing deliveries according to claim 1, wherein each time the door of a smart locker is opened, the controller is configured to record a video of the locker space via a camera of the smart locker and save or forward the video to the database.

19. A computer-implemented system for managing deliveries according to claim 1, wherein the smart locker controller is further configured to perform facial recognition on any individual in an image captured by the one or more cameras.

20. A computer-implemented system for managing deliveries according to claim 1, wherein the smart locker controller is further configured, in response to a request from an associated user device, to open the electronic lock and allow a user to place a return parcel inside for collection by a courier.
